(19) United States
(12) Patent Application Publication
(10) Pub. No.: US 2016/0122159 A1
(43) Pub. Date: May 5, 2016

(54) RETRACTABLE TOE GUARD ASSEMBLY FOR AN ELEVATOR SYSTEM

(71) Applicant: OTIS ELEVATOR COMPANY, Farmington, CT (US)

(72) Inventors: Etienne Delachatre, Chateaubourg (FR); Aurelien Fauconnet, Isdes (FR)

(21) Appl. No.: 14/895,284

(22) PCT Filed: Jun. 5, 2013
(86) PCT No.: PCT/IB2013/001380

§ 371 Date: Dec. 2, 2015

(51) Int. Cl. B66B 13/28

(52) U.S. Cl. CPC B66B 13/285

(57) ABSTRACT

An elevator system including an elevator car having a front wall having an opening allowing entry into the elevator car, a rear wall opposite the front wall, a left wall and a right wall; a platform positioned at an underside of the elevator car; and a toe guard assembly coupled to the platform, the toe guard assembly including a first panel and a second panel, the second panel having an extended position and a retracted position; the second panel movable from the extended position to the retracted position by tray cling in one of a left direction towards the left wall and a right direction towards the right wall.

### FIELD OF INVENTION

The subject matter disclosed herein relates generally to the field of elevator systems, and more particularly, to a retractable toe guard assembly for an elevator system.

### DESCRIPTION OF RELATED ART

Elevator cars typically include a toe guard situated beneath the elevator car. The toe guard is typically rigid and with a nominal height of about 750 mm. A significant amount of clearance beneath the elevator car is required to avoid contact between the toe guard and the bottom of the elevator shaft when the elevator car is situated at a lowest landing. Such contact could cause significant damage to the toe guard due to the rigid and fixed nature of the toe guard.

Elevator systems have included a pit at the bottom of the hoistway, in part, to provide sufficient clearance between the bottom of the elevator car and the bottom of the hoistway. Typical pit configurations provide a sufficient clearance for typical toe guards. More recently, however, elevator pits have been eliminated or reduced in size. Conventional toe guards are not compatible with elevator systems having such pits.

One suggestion for addressing such a situation is shown in U.S. Pat. No. 6,095,288. That document includes a toe guard panel that is moveable from a position where the toe guard extends vertically downward from the elevator car into a position where the toe guard is tucked beneath the elevator car in a nearly horizontal orientation.

### BRIEF SUMMARY

An exemplary embodiment includes an elevator system including an elevator car having a front wall having an opening allowing entry into the elevator car, a rear wall opposite the front wall, a left wall and a right wall; a platform positioned at an underside of the elevator car; and a toe guard assembly coupled to the platform, the toe guard assembly including a first panel and a second panel, the second panel having an extended position and a retracted position; the second panel movable from the extended position to the retracted position by traveling in one of a left direction towards the left wall and a right direction towards the right wall.

Another exemplary embodiment includes a toe guard assembly for use with an elevator car having a front wall having an opening allowing entry into the elevator car, a rear wall opposite the front wall, a left wall and a right wall and a platform positioned at an underside of the elevator car, the retractable toe guard assembly including a first panel and a second panel, the second panel having an extended position and a retracted position; the second panel movable from the extended position to the retracted position by traveling in one of a left direction towards the left wall and a right direction towards the right wall.

Another exemplary embodiment includes a toe guard configured to be used with an elevator system, the toe guard including a stationary panel, configured to be functionally coupled to an elevator car; at least one laterally displaceable panel, functionally coupled to the stationary panel, such that the at least one laterally displaceable panel is configured to move laterally with respect to the stationary panel, decreasing an overall height of the toe guard.

Other aspects, features, and techniques of embodiments of the invention will become more apparent from the following description taken in conjunction with the drawings.

### BRIEF DESCRIPTION OF THE DRAWINGS

Referring now to the drawings wherein like elements are numbered alike in the FIGURES:

FIG. 1 depicts an elevator system in an exemplary embodiment;

FIG. 2 depicts a toe guard assembly coupled to an elevator car platform in an exemplary embodiment;

FIGS. 3-4 depict a toe guard assembly in an extended position in an exemplary embodiment;

FIG. 5 depicts a toe guard assembly in a retracted position in an exemplary embodiment;

FIG. 6 depicts a toe guard assembly in an extended position in another exemplary embodiment; and

FIG. 7 depicts the toe guard assembly of FIG. 6 in a retracted position.

### DETAILED DESCRIPTION

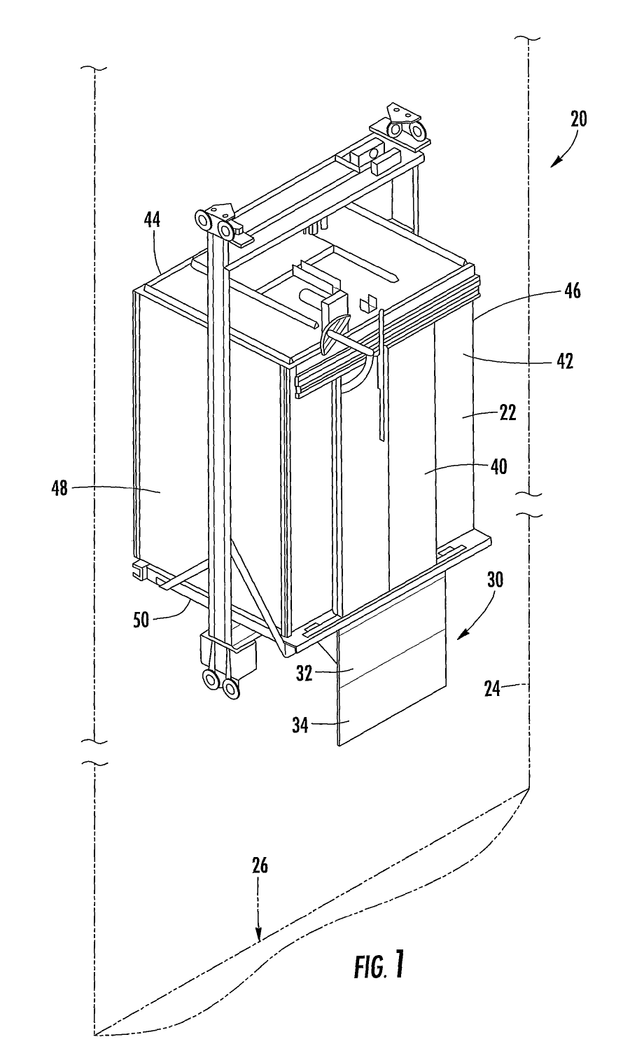

FIG. 1 schematically shows selected portions of an elevator system 20. Only selected portions are illustrated. Those skilled in the art will realize that many other components (e.g., rails, buffers, governors, machines, brakes, drives, controllers, traction members, etc.) may be included in an elevator system. Such components are omitted from the illustration and this discussion for the sake of brevity and because those skilled in the art are already aware of such components and their various configurations.

An elevator car 22 is moveable within a hoistway 24. A surface 26 near the bottom of the hoistway 24 may be the floor of the pit or a bottom hoistway surface in examples that do not include a pit at the bottom of the hoistway 24. Elevator car 22 includes doors 40 that open and close. Doors 40 are positioned over an opening in a front wall 42 that allows entry into elevator car 22. A rear wall 44 of elevator car 22 is opposite front wall 42. A right side wall 46 and left side wall 48 extend between the front wall 42 and rear wall 46. A platform 50 supports a bottom of elevator car 22.

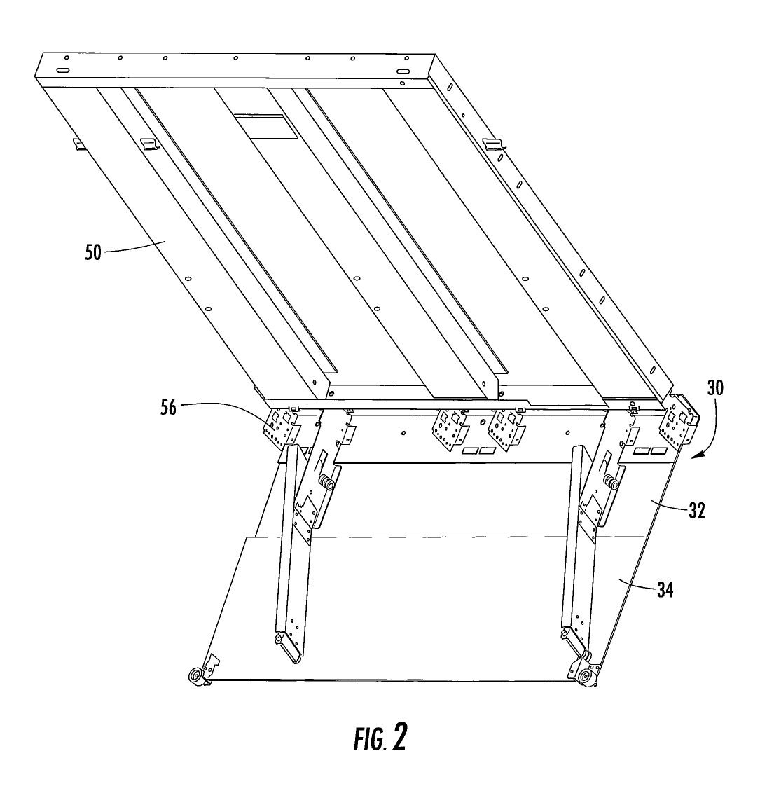

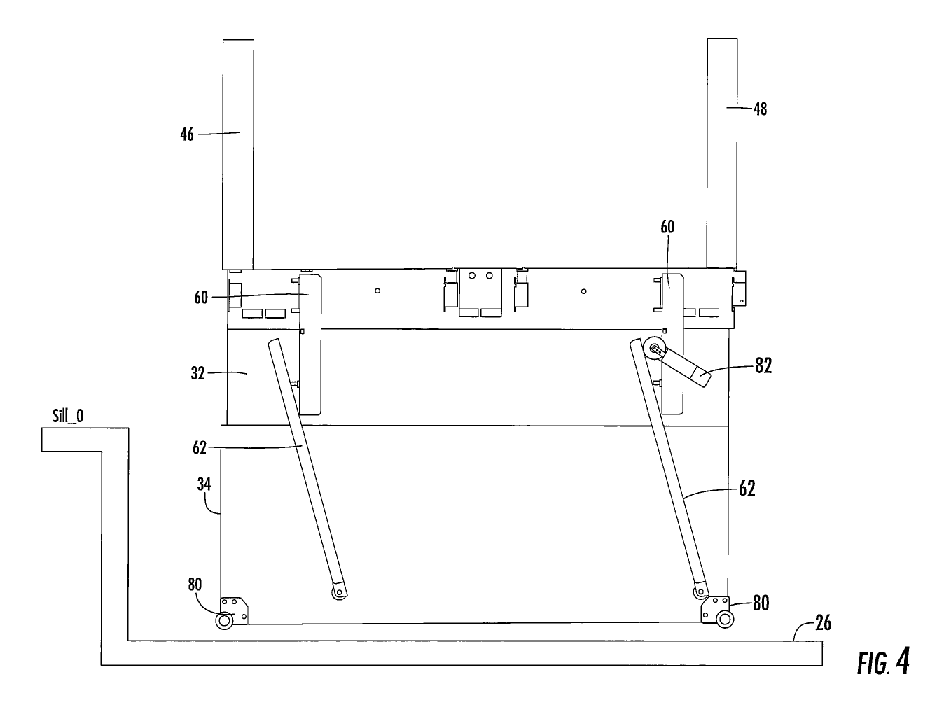

A toe guard assembly 30 is provided on the elevator car 22 to cover the space between a bottom of the elevator car 22 and an adjacent landing, when the elevator car 22 is in the proximity of the landing. If, for any reason, the hoistway doors (not shown) were to open before the car is properly aligned with the landing. One function of the toe guard assembly 30 is to prevent people from falling in the hoistway during rescue operations when the car door is not aligned with the landing door. The presence of the toe guard assembly 30 impacts how close the elevator car 22 can get to the bottom surface 26 of a hoistway. The example toe guard assembly 30 is moveable from an extended position (shown in FIGS. 2-4) into a retracted position (shown in FIG. 5) that allows the elevator car 22 to descend closer to the surface 26 than it otherwise would be able to if the toe guard assembly 30 remained in the extended position, as the height of the retracted toe guard is significantly less than the height of the extended toe guard.

Referring to FIG. 2, an example elevator toe guard assembly 30 includes a first panel 32 and a second panel 34. The toe guard assembly 30 includes at least one fixed bracket 56 for mounting the toe guard assembly 30 to elevator car platform 50. The second panel 34 is moveable relative to the first panel 32 between an extended position (shown in FIGS. 2-4, for example) and a retracted position (shown in FIG. 5, for example).

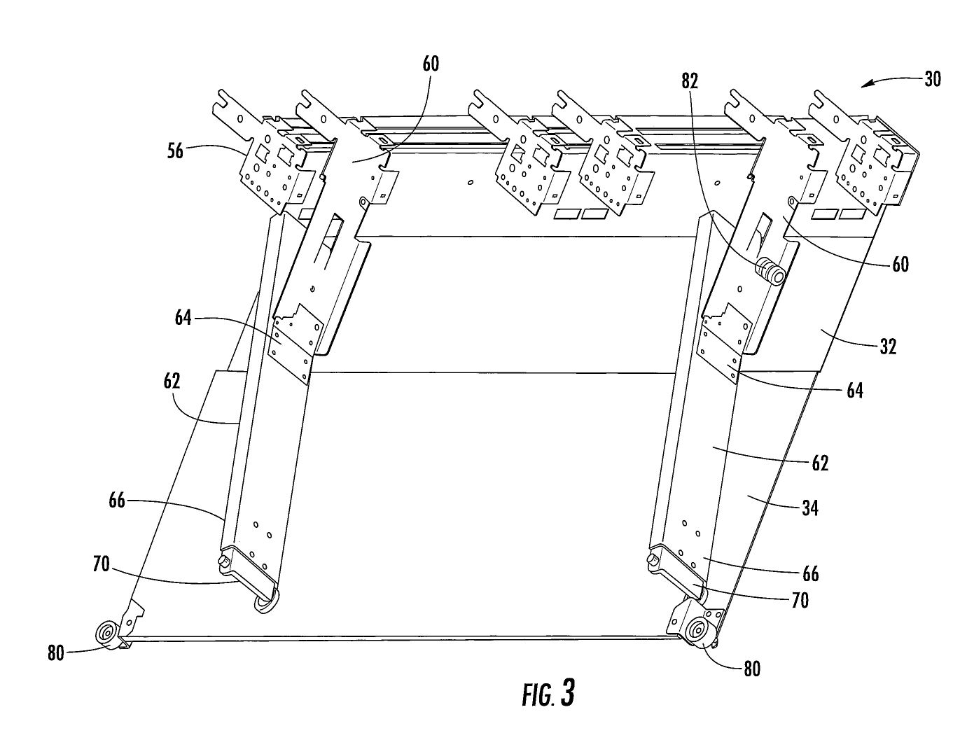

FIG. 3 depicts the toe guard assembly 30 in an extended position in an exemplary embodiment. First panel 32 is secured to fixed bracket 56 in an immovable manner (e.g., through fasteners). The panel 32 may be secured to the fixed bracket 56 using a rigid or flexible connection. The use of a flexible connection may improve sound dampening as well as allowing some movement of the toe guard assembly 30 to reduce stresses on the system. In an exemplary embodiment, a pair of support arms 60 is secured to fixed bracket 56 in an immovable manner (e.g., through fasteners). Support arms 60 extend downwards, in a direction of downwards travel of elevator car 22. A hinge arm 62 is coupled to each support arm 60 through a hinge member 64. Hinge member 64 may be secured to a hinge arm 62 at a position between distal ends of the hinge arm 62. Although two support arms 60 and two hinge arms 62 are shown, it is understood that embodiments may use one support arm 60 and one hinge arm 62 or multiple support arms 60 and hinge arms 62. The particular hardware shown in FIGS. 2 and 3 is an exemplary embodiment, and it is understood that other apparatus may be used to allow the second panel 34 (or a plurality of panels) to move relative to the first panel 32 as described herein.

A distal end 66 of each hinge arm 64 is secured to the second panel 34 through a pivot member 70 to allow the second panel 34 travel along an arcuate path when transitioning from an extended state to a retracted state, and vice versa. The pivot member 70 may include a pin secured to the second panel 34 and a socket mounted at distal end 66 of hinge arm 62 (e.g., a roller). One or more rollers 80 are provided on a distal end, or edge, of second panel 34. Other examples of rollers 80 including sliding members or skates.

A optional switch 82 is positioned on a support arm 60. When the toe guard assembly 30 is in the extended position, hinge arm 62 contacts switch 82 to generate a signal indicating that the toe guard assembly 30 is in the extended state. The signal from switch 82 may be used by an elevator controller to determine if it is safe to allow the elevator car 22 to travel.

FIG. 4 is a rear view of the toe guard assembly 30 in the extended state as the elevator car approaches surface 26 in the bottom of hoistway 24. As the elevator car 22 continues downwards, rollers 80 contact the surface 26 once the elevator car 22 descends to a sufficiently low position. FIG. 5 is a rear view of the toe guard assembly 30. As shown in FIG. 5, the rollers 80 have contacted the surface 26. Continued movement of the elevator car 22 in a downward direction results in the second panel 34 sliding in a left direction, towards left wall 48. In exemplary embodiments, the second panel 34 travels towards the portion of the hoistway where the counterweight is mounted, as there is typically extra space in that region. In the retracted position, the second panel 34 may extend beyond left wall 48 by a distance, D, of about 290 mm. The height, H, of the toe guard assembly 30 in the extended state may be about 790 mm, and about 450 mm in the retracted state.

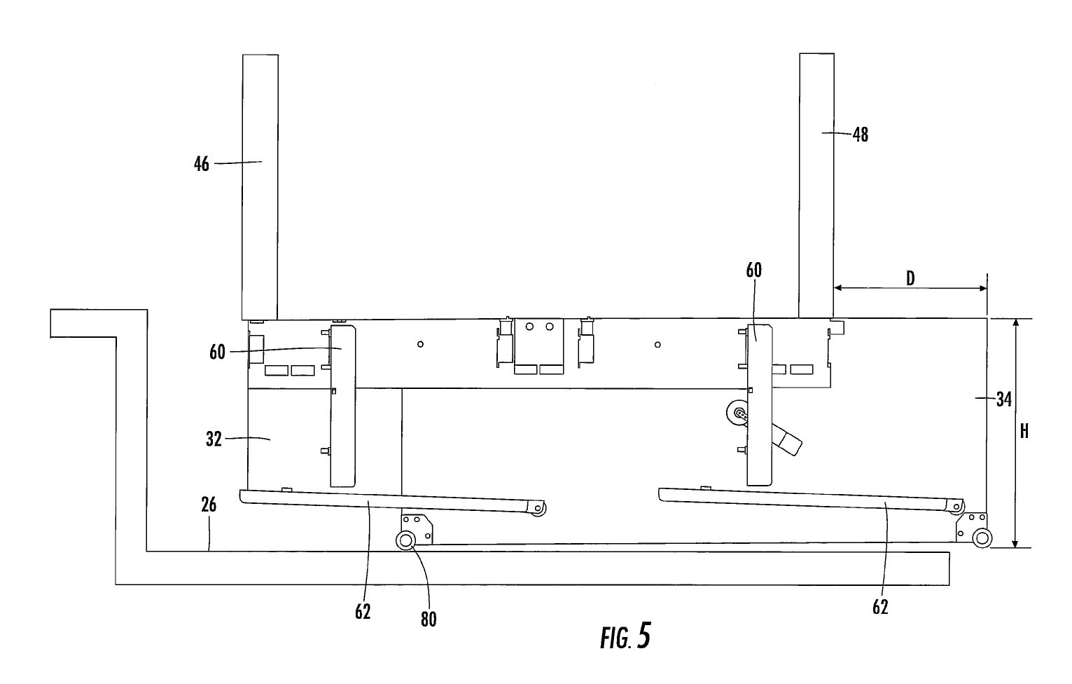

FIG. 6 depicts a toe guard assembly 100 in an extended position in another exemplary embodiment. Toe guard assembly 100 includes a first panel 102 secured to fixed bracket 101 in an immovable manner (e.g., through fasteners). Second panel 104 and third panel 106 retract as described herein. A pair of support arms 160 is secured to fixed bracket 101 in a pivotal manner. For example, a first end of each support arm 160 may receive a pin 161 extending from first panel 102. Support arms 160 extend downwards, in a direction of downwards travel of elevator car 22. Hinge arms 162 are coupled to each support arm 160 through a pivot member 165. Pivot member 165 may be formed by a pin that extends through support arm 160 and hinge arm 162 to allow rotational movement between support arm 160 and hinge arm 162. Although two support arms 160 and two hinge arms 162 are shown, it is understood that embodiments may use one support arm 160 and one hinge arm 162 or more than two support arms 160 and two hinge arms 162.

Second panel 104 is positioned below the first panel 102 and is secured to the support arms 160 and hinge arms 162 at pivot members 165. Pivot members 165 allow the second panel 104 travel along an arcuate path when transitioning from an extended state to a retracted state, and vice versa. Each pivot member 165 may include a pin secured to the second panel 104 that extends into a socket in the support arm 160 and hinge arm 162.

A distal end 166 of each hinge arm 162 is secured to a third retractable panel 106 through a pivot member 170 to allow the third panel 106 to travel along an arcuate path when transitioning from an extended state to a retracted state, and vice versa. The pivot member 170 may include a pin secured to the third panel 106 and a socket at a distal end 166 of hinge arm 162. Rollers 180 contact the surface 26 once the elevator car 22 descends to a sufficiently low position, similar to rollers 80 described above. The particular hardware shown in FIG. 6 is an exemplary embodiment, and it is understood that other apparatus may be used to allow the second panel 104 and third panel 106 to move relative to the first panel 102 as described herein.

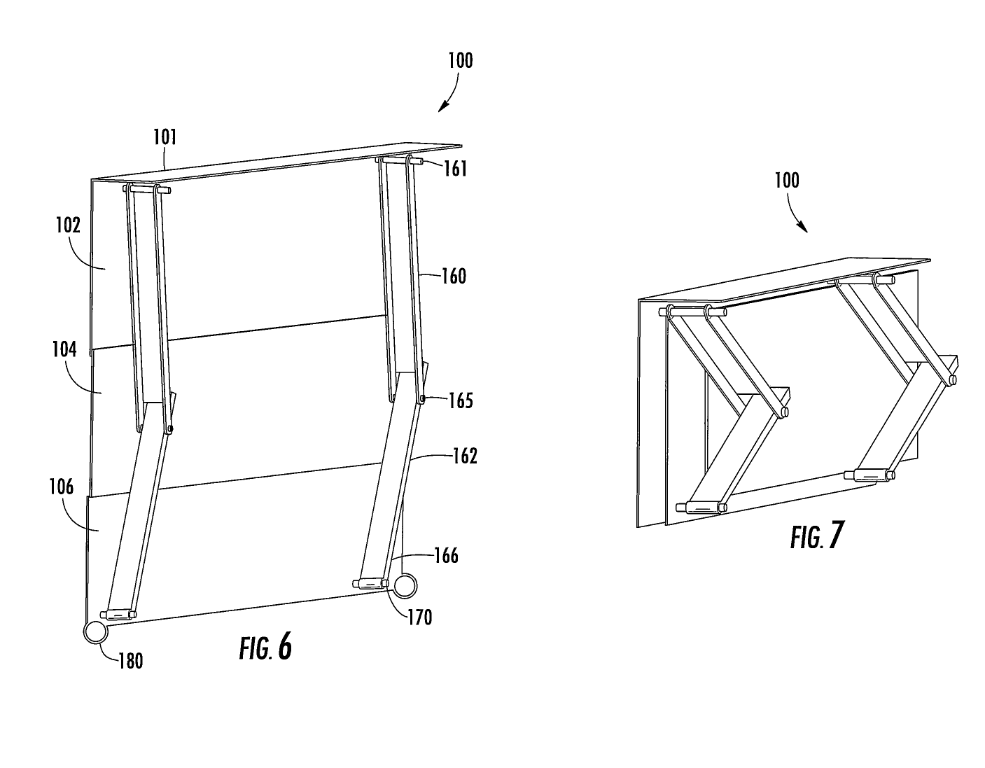

FIG. 7 is a rear perspective view of the toe guard assembly 100 in a retracted position. As shown in FIG. 7, both the second panel 104 and the third panel 106 are in a retracted position. As the elevator car 22 moves downwards, both the second panel 104 and the third panel 106 slide in a left direction, towards left wall 48. In exemplary embodiments, the second panel 104 and the third panel 106 travel along an arcuate path towards the portion of the hoistway where the counterweight is mounted, as there is typically extra space in that region. In the retracted position, the second panel 104 and the third panel 106 may extend beyond left wall 48 by a distance of about 222 mm. The height, H, of the toe guard assembly 30 in the extended state may be about 690 mm, and about 298 mm in the retracted state.

The second panel 34 in FIGS. 4 and 5, and the second panel 104 and the third panel 106 in FIGS. 5 and 6, are shown traveling to towards the left wall 48 during retraction. It is understood that the retracting panels may be hinged in a way to cause the retracting panels to travel in a right direction towards right wall 46 upon retraction. Further, if multiple retracting panels are used, as shown in FIGS. 6 and 7, the retracting panels may travel in the same direction or in different directions. In further exemplary embodiments, additional panels may be used in a manner similar to that shown to achieve desired extended and retracted heights.

The terminology used herein is for the purpose of describing particular embodiments only and is not intended to be limiting of the invention. While the description of the present invention has been presented for purposes of illustration and description, it is not intended to be exhaustive or limited to the invention in the form disclosed. Many modifications, variations, alterations, substitutions, or equivalent arrangement not hereto described will be apparent to those of ordinary skill in the art without departing from the scope and spirit of the invention. Additionally, while the various embodiments of the invention have been described, it is to be understood that aspects of the invention may include only some of the described embodiments. Accordingly, the invention is not to be seen as being limited by the foregoing description, but is only limited by the scope of the appended claims.

1. An elevator system comprising:
an elevator car having a front wall having an opening allowing entry into the elevator car, a rear wall opposite the front wall, a left wall and a right wall;
a platform positioned at an underside of the elevator car; and
a toe guard assembly coupled to the platform, the toe guard assembly including a first panel and a second panel, the second panel having an extended position and a retracted position;
the second panel movable from the extended position to the retracted position by traveling in one of a left direction towards the left wall and a right direction towards the right wall.

2. The elevator system of claim 1 wherein the toe guard assembly includes:
a fixed bracket, the fixed bracket secured to the platform;
a support arm secured to the fixed bracket; and
a hinge arm hingedly coupled to the support arm;
wherein the second panel is pivotally secured to the hinge arm at a pivot member.

3. The elevator system of claim 1 further comprising:
a further second panel movable from the extended position to the retracted position by traveling in one of the left direction towards the left wall and the right direction towards the right wall.

4. The elevator system of claim 1 wherein:
the toe guard assembly includes a roller positioned at an edge of the second panel, the roller for contacting a pit surface of a hoistway.

5. A toe guard assembly for use with an elevator car having a front wall having an opening allowing entry into the elevator car, a rear wall opposite the front wall, a left wall and a right wall and a platform positioned at an underside of the elevator car, the retractable toe guard assembly comprising:
a first panel and a second panel, the second panel having an extended position and a retracted position;
the second panel movable from the extended position to the retracted position by traveling in one of a left direction towards the left wall and a right direction towards the right wall.

6. The toe guard assembly of claim 5 further comprising:
a fixed bracket, the fixed bracket secured to the platform.

7. The toe guard assembly of claim 6 further comprising:
a support arm secured to the fixed bracket.

8. The guard assembly of claim 7 further comprising:
a hinge arm hingedly coupled to the support arm.

9. The toe guard assembly of claim 8 wherein:
the second panel is movably secured to the hinge arm.

10. The toe guard assembly of claim 9 wherein:
the second panel is pivotally secured to the hinge arm at a pivot member.

11. The toe guard assembly of claim 5 further comprising:
a further second panel movable from the extended position to the retracted position by traveling in one of the left direction towards the left wall and the right direction towards the right wall.

12. The toe guard assembly of claim 5 further comprising:
a roller positioned at an edge of the second panel, the roller for contacting a pit surface of a hoistway.

13. A toe guard configured to be used with an elevator system, the toe guard comprising:
a stationary panel, configured to be functionally coupled to an elevator car;
at least one laterally displaceable panel, functionally coupled to the stationary panel, such that the at least one laterally displaceable panel is configured to move laterally with respect to the stationary panel, decreasing an overall height of the toe guard.

14. The toe guard of claim 13, wherein the at least one laterally displaceable panel is configured to move laterally with respect to the stationary panel when contacting a stationary surface under the elevator car.

15. The toe guard of claim 14, further comprising at least one roller coupled to a bottom most one of the at least one laterally displaceable panels such that the roller moves along the stationary surface under the elevator car when the bottom most one of the at least one laterally displaceable panels moves laterally with respect to the stationary panel.

16. The toe guard of claim 13, wherein the at least one laterally displaceable panel does not rotate with respect to the stationary panel when moving laterally.

17. The toe guard of claim 13 further comprising:
a fixed bracket, the fixed bracket configured to be secured to an elevator car platform;
a support arm secured to the fixed bracket and;
a hinge arm hingedly coupled to the support arm;
wherein the at least one laterally displaceable panel is movably secured to the hinge arm.

18. The toe guard of claim 17 wherein:
the at least one laterally displaceable panel is pivotally secured to the hinge arm at a pivot member.

19. The toe guard of claim 17 further comprising:
a further laterally displaceable panel movable from an extended position to a retracted position by traveling in one of the left direction towards the left wall and the right direction towards the right wall.

20. The toe guard of claim 17 further comprising:
a roller positioned at an edge of the at least one laterally displaceable panel, the roller for contacting a pit surface of a hoistway.
